(19) United States
(12) Patent Application Publication
(10) Pub. No.: US 2014/0202131 A1
(43) Pub. Date: Jul. 24, 2014

(54) PLASMA MICRO-THRUSTER

(71) Applicant: Roderick William Boswell, O'Connor (AU)

(72) Inventor: Roderick William Boswell, O'Connor (AU)

(21) Appl. No.: 14/117,277

(22) PCT Filed: May 12, 2012
(86) PCT No.: PCT/AU2012/000532

§ 371 Date: Nov. 12, 2013

(30) Foreign Application Priority Data
May 12, 2011 (AU) 2011901801

(51) Int. Cl. F03H 1/00

(52) U.S. Cl. CPC F03H 1/00
USPC 60/202

(57) ABSTRACT

A plasma micro-thruster, including: an elongate and substantially non-conductive tube having a first end to receive a supply of propellant gas, and an open second end to act as an exhaust; first, second, and third electrodes extending circumferentially around the tube and being mutually spaced along a longitudinal axis of the tube, the third electrode being longitudinally interposed between the first and second electrodes; wherein the tube and the first, second and third electrodes are configured to generate a plasma from propellant gas flowing though the tube from the first end of the tube when the third electrode receives radio frequency power and the first and second electrodes are electrically grounded relative to the third electrode, such that the expansion of the plasma from the open end of the tube generates a corresponding thrust.

### TECHNICAL FIELD

The present invention relates to micro-thrusters for use in space applications, where thrust (force) is achieved through the generation of a plasma plume.

### BACKGROUND

Micro-thrusters find use in space applications where thrusts of the order of milli Newton are used to manoeuvre spacecraft. Such manoeuvring may be, for example, to direct a spacecraft into a desired orbit, to maintain the spacecraft's position within a desired orbit, or to remove the spacecraft from one orbit to another (e.g., parking in a so-called ‘graveyard’ orbit, or atmospheric re-entry). One matter of concern in the design of thrusters for spacecraft is to minimise weight.

It is desired to provide a plasma micro-thruster that alleviates one or more difficulties of the prior art, or that at least provides a useful alternative.

### SUMMARY

In accordance with the present invention, there is provided a plasma micro-thruster, including:
an elongate and substantially non-conductive tube having a first end to receive a supply of propellant gas, and an open second end to act as an exhaust;
first, second, and third electrodes extending circumferentially around the tube and being mutually spaced along a longitudinal axis of the tube, the third electrode being longitudinally interposed between the first and second electrodes;
wherein the tube and the first, second and third electrodes are configured to generate a plasma from propellant gas flowing though the tube from the first end of the tube when the third electrode receives radio frequency power and the first and second electrodes are electrically grounded relative to the third electrode, such that the expansion of the plasma from the open end of the tube generates a corresponding thrust.

The present invention also provides a plasma micro-thruster, including:
a tube having a length greater than its width, receiving at one end a supply of propellant gas, and having the other end open as an exhaust;
a first and a second conductive electrodes in a spaced-apart arrangement surrounding the tube, each electrodes being connected to zero relative potential; and
a third conductive electrode interposed between the first and second electrodes and surrounding the tube and adapted to be supplied with radio frequency power; and
wherein a plasma is ignited within the tube with the flow of propellant gas into said tube and the application of radio frequency power to said third electrode.

The tube of the micro-thruster is preferably composed of a ceramic material. In a preferred form the micro-thruster includes a plenum chamber configured to supply a positive pressure of the propellant gas to the corresponding end of the tube. Advantageously, a gas flow rate controller is disposed between the plenum chamber and the corresponding end of the tube. The micro-thruster preferably includes a radio frequency power supply connected to the third electrode.

### BRIEF DESCRIPTION OF THE DRAWINGS

Some embodiments of the invention are hereinafter described, by way of example only, with reference to the accompanying drawings, wherein:

FIG. 1 is a schematic side view of a micro-thruster in accordance with some embodiments of the present invention;

FIG. 2 is a schematic side view of a micro-thruster in accordance with some embodiments of the present invention and in an experimental arrangement to measure parameters of the plasma generated by the micro-thruster, including a camera and a Langmuir probe;

FIG. 3 is a graph of the measured intensity of the 488 nm Ar II line as a function of radial distance from the central axis of the plasma plume, for upstream Argon gas pressures of 0.54 Torr, 1.6 Torr. 2.3 Torr and 3.1 Torr, respectively, and 40 W RF power;

FIGS. 4 and 5 are camera images of plasma plumes generated by the micro-thruster of FIG. 2 for an Argon gas pressure of 1.6 Torr and RF powers of 40 W and 6 W, respectively;

FIG. 6 is a graph of (i) normalized ion current measured by the Langmuir probe biased at −27 V and located at z=15 mm (solid circles), and (ii) normalized RF current Iₙₒₛ² (open squares), both as a function of RF power; the normalization being to the corresponding values for the maximum RF power of 30 W; and

FIG. 7 is a graph of the ion saturation current as a function of position along the longitudinal axis of the micro-thruster, as measured by the Langmuir probe biased at −27 V for 9.5 W RF power (V_{rf}=250 V) and a plenum pressure of 1.5 Torr. The solid vertical arrow 502 and the dotted vertical arrow 504 indicate the Langmuir probe's respective positions for the measurement of the full characteristic (to determine the electron temperature) and the measurements of FIG. 6. The solid horizontal line 506 indicates the position of the RF electrode.

### DETAILED DESCRIPTION

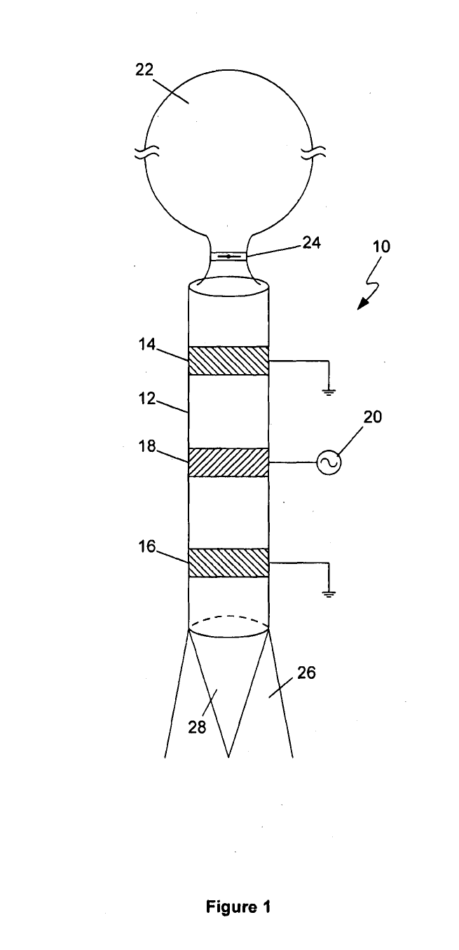

As shown in FIG. 1, a micro-thruster 10 includes an elongate tube 12 composed of a substantially rigid and substantially electrically non-conducting material. In the described embodiments, the tube 12 is composed of alumina, but it will be apparent that other materials with the described properties can be used in other embodiments, including other ceramic materials. The relative dimensions of the tube 10 are typically such that it is considerably longer than its outer diameter; for example. in some embodiments the aspect -ratio is about a factor of ten. Two mutually spaced and electrically conductive outer electrodes 14, 16 surround the tube 12, and are maintained at a zero relative potential. In the described embodiments, the outer electrodes 14, 16 are in the form of generally cylindrical metal bands that extend circumferentially to around the tube 12 and whose height (i e., dimension along the longitudinal axis of the tube 12) is approximately equal to the outer diameter of the tube 12, and the outer electrodes 14, 16 are mutually spaced along the longitudinal axis of the tube 12 by a distance of about 3 outer diameters (between the nearest edges of the electrodes 14, 16). A third or central electrode or metal band 18, also surrounding the tube 12, is situated centrally between the first and second bands 14, 16, and in use is connected to a radio frequency source or generator 20. The micro-thruster 10 can be encased in a non-conducting and vacuum-tight support structure (not shown).

One end of the tube 12 is connected to a gas plenum chamber 22 that, in use, contains a propellant gas under positive pressure. The propellant gas is introduced into the tube 12 in a controlled manner by a suitable mechanism (e.g., a mass flow controller) 24, that allows the flow rate of gas into the tube 12 to be controlled as desired. The resulting flow of gas 26 escaping from the open (exhaust) end of the tube 12 in itself generates thrust due to Newton's third law of motion.

The application of radio frequency power with a frequency from below 100 kHz to above 1 GHz to the central electrode 18 causes an avalanche breakdown of the gas passing through the tube 12 to establish a plasma plume 28. The plasma plume 28 projects outwards from the exhaust end of the tube 12 and increases the overall thrust over that generated by the gas stream 26 alone due to ion acceleration (possibly to supersonic velocities) caused by the plasma expansion.

When used to control the movement of a spacecraft, the micro-thruster 10 is mounted to the spacecraft so that the open (exhaust) end of the tube 12 is directed away from the spacecraft into space, and, where a single micro-thruster 10 is used, in a direction opposite to the desired direction of the spacecraft's movement. In order to control the direction of thrust relative to the spacecraft, the micro-thruster 10 can be mounted to the spacecraft via an adjustable support or mount that allows the spatial orientation of the micro-thruster 10 relative to the spacecraft to he remotely and correspondingly adjusted and controlled, for example by mechanical means (e.g., using gimbals), and/or by electrical means (e.g., using magnetic or electric fields). Additionally or alternatively, a plurality of micro-thrusters 10 can be mounted orthogonally to allow for 3-axis control of the spacecraft.

The micro-thrusters 10 described herein are compact and efficient in converting electrical energy to thrust, and therefore can be much lighter than prior art thrusters. As the described micro-thrusters 10 use non-metallic materials (e.g., ceramics) in contact with the plasma 28, this avoids another of the difficulties suffered by prior art thrusters, namely metallic particles generated by sputtering endangering the spacecraft's solar panels.

In one embodiment, the ceramic tube 12 has an outside diameter of 3 mm and an inside diameter of 1.5 mm, and a length of about 2 cm. The propellant gas used is argon, having a flow rate of about 10 to 1000 seem, more preferably about 100 sccm. The pressure in the plenum chamber 22 is about 7 Torr, and the pressure downstream of the tube 12 in the gas exhaust 26 is about 1 Torr. For about 10 watts generated by the radio frequency generator 20 at a frequency of 13.56 MHz, a plasma 28 was ignited, and observed to extend many centimeters downstream in a cone-shaped plume 28 with a half angle of less than 5 degrees.

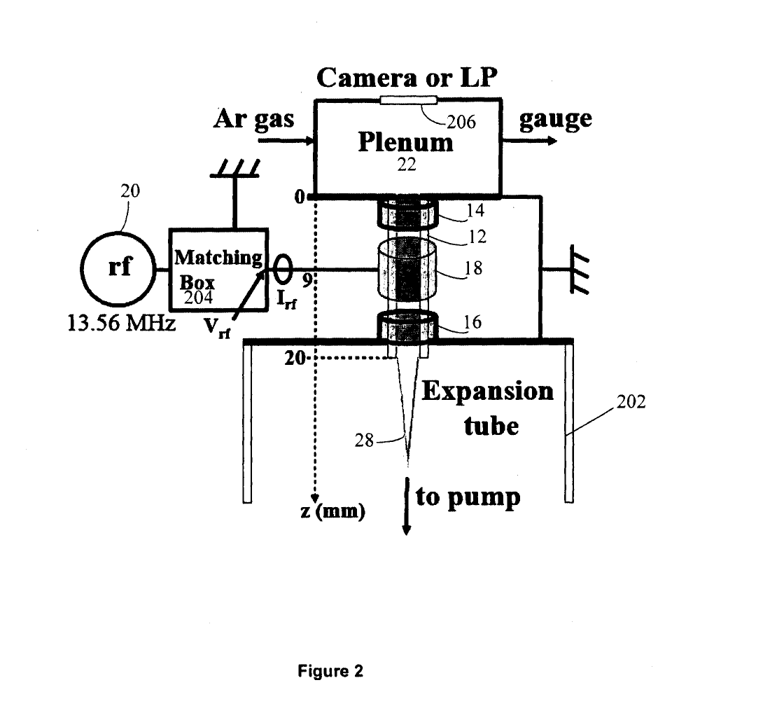

In a further embodiment, illustrated schematically in FIG. 2, a micro-thruster 10 has cylindrical ceramic tube 12 that is 2 cm long with inner and outer diameters of 4.2 mm and 5.3 mm, respectively. The central electrode 18 is in the form of a 6 mm high copper ring (A_{rf}˜1 cm²) and the two outer electrodes 14, 16 are 3 mm high grounded copper rings 14, 16 placed upstream and downstream of the central electrode 18 and separated from it (edge-to-edge) by 3 mm. A vertical z axis with z=0 cm defined as the location of the upstream (gas inlet) end of the tube 12, so that z=20 mm corresponds to the open (exhaust) end of the tube 12 and hence the start of the geometric expansion of the plasma plume 28.

The lower open (exhaust) end of the tube 12 projects into a 72 cm long, relatively large (5 cm) diameter glass tube 202 contiguously attached to a 30 cm long, 16 cm diameter aluminum vacuum chamber (not shown) equipped with a primary pump and a Baratron gauge. Argon gas is introduced upstream of the micro-discharge into a small cavity or plenum chamber 22 (1.2 cm wide and 4 cm in diameter) equipped with a Convectron gauge. The system was pumped down to a base pressure of ˜3×10⁻³ Torr, and gas flows ranging from a few tens to hundreds of sccm resulted in an operating pressure range of 0.3-7 Torr as measured in the plenum chamber 22 and about 2.2 times lower as measured in the aluminium vacuum chamber.

RF power from about 5 to about 40 W was coupled to the plasma using a π impedance matching network 204 equipped with a Rogowski coil to measure the RF current and a×1/1000 HV Tektronics probe to measure the RF voltage. A Bird power meter was inserted between the RF generator 20 and the impedance matching box 204 to measure both the forward and reflected power and deduce the RF power P_{rf} dissipated in the discharge. At any time, either a digital camera (Casio Exilim EX-F1) or an axially movable Langmuir probe (LP) with a 1 mm in diameter nickel tip was mounted on a back port/window 206 of the plenum chamber 22 to measure either the radial profile or the axial (longitudinal) profile of the plasma density. Although an RF filter was used in the LP data acquisition system, the small plasma cavity size did not allow for the LP to be fully RF compensated. Previous experiments with and without RF compensation in a larger scale device operating at lower gas pressure (a few mTorr) have shown that the error bar for Tₑ is of the order of ±0.5 eV for the electron bulk.

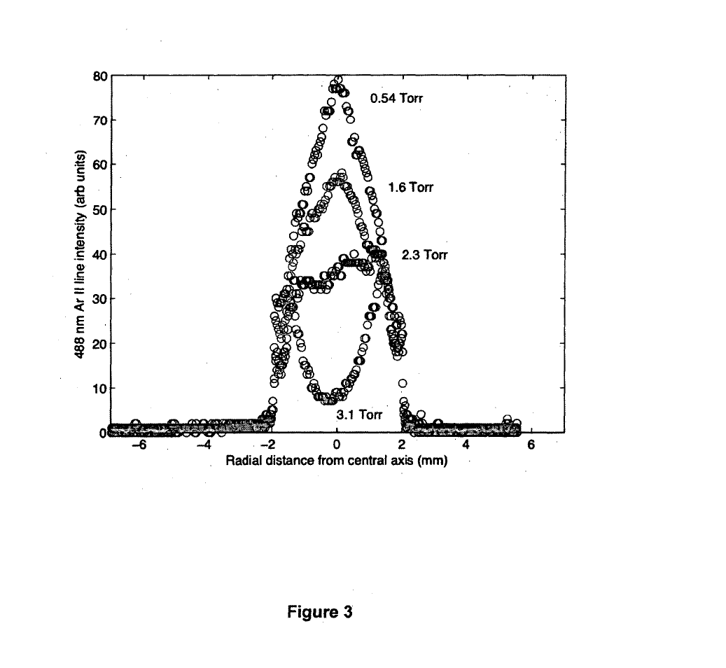

The resulting capacitive radiofrequency (13.56 MHz) micro-discharge was about 2 cm long and 4.2 mm in diameter. Images of the discharge cross section were taken using a 488 nm filter of 10 nm bandwidth inserted between the plenum viewing port 206 and the digital camera lens. Although the focus was manually set about halfway into the cylindrical discharge, the measurement was integrated over the whole discharge volume. The results of the Ar II line intensity across the horizontal diameter as a function of radial distance are shown in FIG. 3 for an RF power of 40 W and four upstream pressures of 0.54 Torr, 1.6 Torr, 2.3 Torr and 3.1 Torr, respectively. The 487.986 nm Ar II line corresponds to the 4p²D^{o}-4s²P transition and the light intensity is nₑ² in the coronal model, assuming a two-step ionization where nₑ is the electron density. Above 3 Torr. the discharge exhibits an annulus of maximum intensity located about mid-radius. and expands as a collimated beam over a few cm with striations. presumably resulting from shock waves from the gas flow appearing above 5 Torr. The mode of interest is the low pressure mode (less than ˜3 Torr) where the density peaks on the central axis with a broader plasma plume extending over about 1 cm.

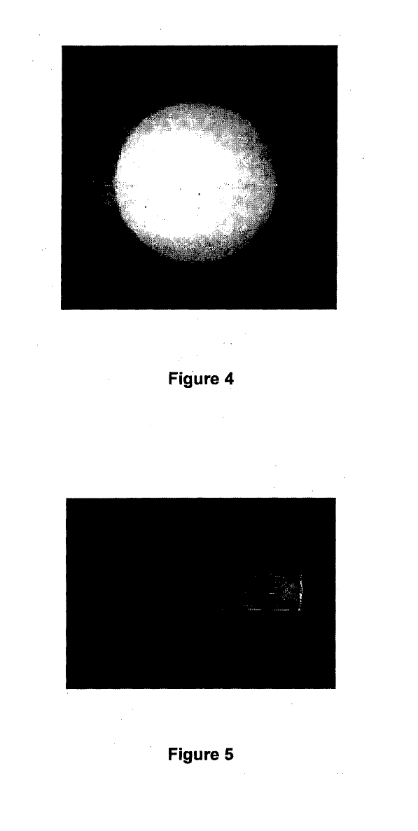

Images of the discharge cross section and of the discharge expansion were taken (without the Ar II filter) and are shown in FIGS. 4 and 5 for a pressure of 1.6 Torr and RF powers of 40 W and 6 W, respectively. Although the radial sheath edge position cannot be spatially resolved, the density ratio between centre (r=0 mm) and edge (r=2 mm) in the coronal model is estimated to be about 4 at 1.5 Torr (FIG. 3). Measurements of the peak breakdown voltage V_{break} using the HV probe provide a Paschen curve with a minimum of V_{break}=230 V around 1.5 Torr. Once ignited, the plasma can be sustained for peak electrode voltages lower than V_{break} and RF powers of a few watts only.

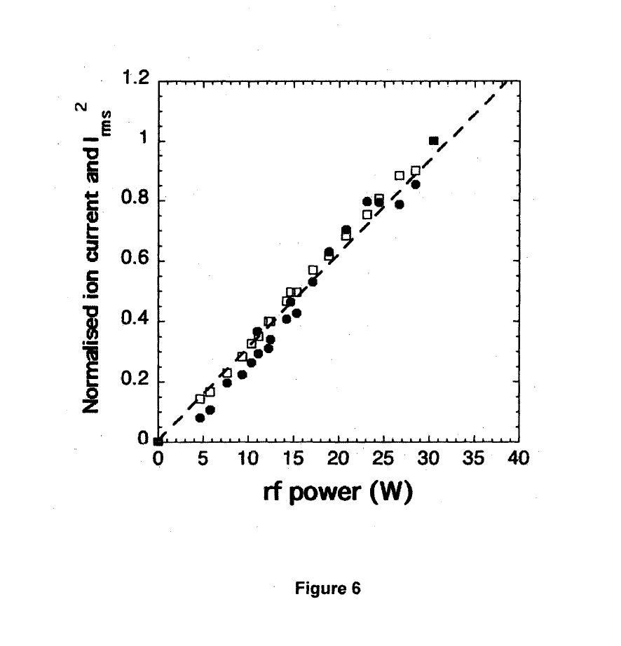

FIG. 6 shows both the ion saturation current Iₛₐₜ measured with the LP biased at −27 V and positioned at z=15 mm, and I_{rf}² (where I_{rf}² is the mean square value of the current measured with the Rogowski probe) versus increasing RF power from 5 to 30 W. The linear variation of I_{rf}² with RF power demonstrates that the impedance of the discharge is constant. The linear variation of Iₛₐₜ with RF power suggests acceleration of secondary electrons across the RF sheath as the dominant electron heating process rather than RF sheath heating. A LP characteristic taken from −100 V to 80 V was measured at 19.7 W (for a peak RF voltage V_{rf}=380 V), 1.5 Torr with the probe located at z=4 mm (near the upstream edge of the discharge), giving a plasma potential of 15 V and a bulk electron temperature of 3±0.5 eV. The density estimated using this electron temperature of 3 eV and Sheridan's sheath expansion model for a probe bias of −80 V is about 2.8×10¹¹ cm⁻³ at z=4 mm. Using a particle balance for a cylindrical argon discharge of length 20 mm and radius 2.1 mm and a single Maxwellian distribution for electrons yields a calculated electron temperature of about 2 eV for a gas temperature of 300 K.

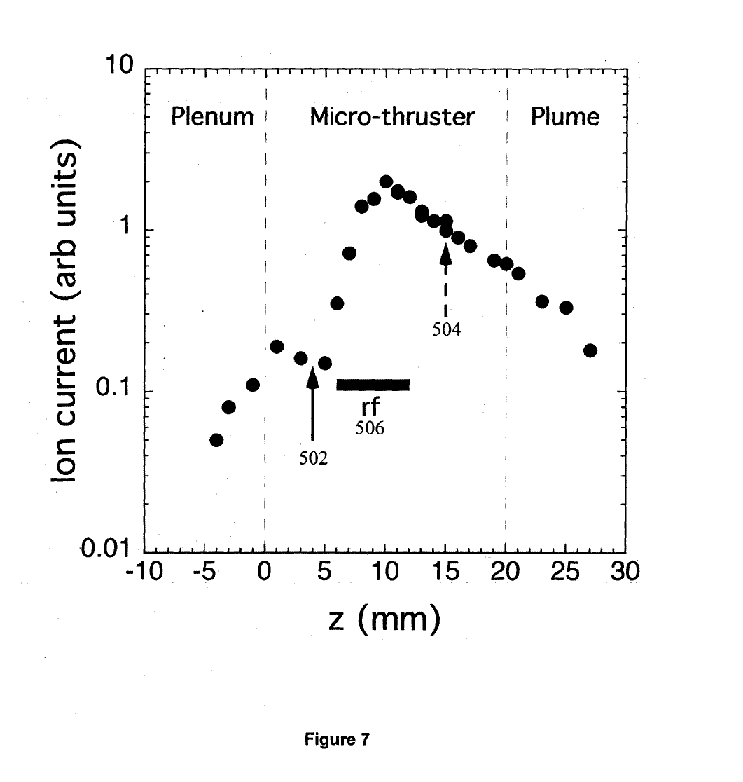

The Iₛₐₜ axial profile obtained with the probe biased at about '27 V is shown in FIG. 7 for 9.5 W RF power (V_{rf}=250 V) and a plenum chamber pressure of 1.5 Torr. When the probe was inserted into the discharge by more than 8 mm. the upstream pressure gradually increased by 0.1 Torr every 2 mm to reach 2.3 Torr at z=20 mm as a result of flow constriction. From FIG. 3, this would give a value underestimated by at least 25%. The flow constriction could also be the source of the density dip around z=5 mm, where the uncertainty on Iₛₐₜ could be as high as 50%. FIG. 7 shows that towards the upstream side of the tube 12 (z=6-10 mm), the ion current (and hence the plasma density) increases exponentially by an order of magnitude to peak at z=10 mm which corresponds to the centre of the RF electrode (z˜9 mm) 20. From this maximum value, the ion current decays exponentially towards the exhaust opening of the tube 12. This asymmetry in the axial profile is likely a result of the gas flow and geometric expansion. Since the ion current has been measured to increase linearly with power (FIG. 6), scaling factors for RF power and axial position can be applied to the full characteristic taken at z=4 mm for 19.7 W to deduce a peak plasma density of 1.8×10¹² cm⁻³ at z=10 mm (the ‘centre’ of the discharge) for a power of 9.5 W.

These measurements allow the development of a global model of the discharge where the plasma parameters can be derived from a power balance assuming a single Maxwellian for the electrons (Tₑ=3 eV):

$${P}_{\text{?}} \sim {qA}_{\text{?}} {n}_{\text{?}} \text{?} ( {E}_{\text{?}} ( {T}_{\text{?}} ) + 2 {T}_{\text{?}} + 0.83 β {V}_{\text{?}} ) \\ \text{?} \text{indicates text missing or illegible when filed} \qquad ( \text{?}$$

where P_{rf} is the RF power, q is the electron charge. Aₚₗₐₛₘₐ˜2.9 cm² is the plasma wall loss area (ceramic surface area and two ends), nₛₕ is the plasma density at the radial sheath edge.

$$\text{?} = \sqrt{\frac{qT \text{?}}{\text{?}}}$$

$$\text{?} \text{indicates text missing or illegible when filed}$$

is the Bohm velocity (M is the ion mass), E_{c}(Tₑ) is the collisional energy loss per electron-ion pair in argon.

$$\text{?} = \text{?} = \text{?}$$

$$\text{?} \text{indicates text missing or illegible when filed}$$

corresponds to the voltage divider formed by the ceramic and the plasma sheath in between the RF electrode and the plasma bulk (the capacitance of the ceramic of thickness d=0.6 mm and dielectric constant ˜10×ε₀ is

$${C}_{ceramic} = \frac{\text{?}}{d} \sim 1.5 pF ) , \\ \text{?} \text{indicates text missing or illegible when filed}$$

and V_{rf} is the peak voltage applied on the RF electrode. The coefficient of 0.83 in equation (1) results from the asymmetry of the discharge (Aₚₗₐₛₘₐ˜3×A_{rf}).

Since the sheath capacitance, hence β, is also a function of nₛₕ, an iterative procedure is applied to determine both β and nₛₕ. The sheath capacitance is written as

$$\text{?} = \text{?} with \text{?} = ( \text{?} \sqrt{\text{?}} ) \text{?} \text{?} \\ \text{?} \text{indicates text missing or illegible when filed} \qquad ( 2 )$$

where s is the collisionless sheath thickness (Kᵢ˜0.82 for RF Child law). For P_{rf}=9.5 W (V_{rf}=250 V which is larger than V_{break}). β is 0.26 (most of the RF voltage is dropped across the ceramic and Vₛₕₑₐₜₕ˜65 V), Cₛₕₑₐₜₕ=4.2 pF˜2.9×C_{ceramic}, nₛₕ is 6.1×10¹¹ cm⁻³, and nₐₓᵢₛ would be about 4× larger at 2.4×10¹² cm⁻³ as deduced from the radial profile of FIG. 3. This value is probably overestimated since the plume loss area is not taken into account which minimizes Aₚₗₐₛₘₐ (equation (1)). Since this value is of the same order as the measured density of 1.8×10¹² cm⁻³ for 9.5 W at z=10 mm, important parameters can be derived from the model. The mean free path for ion-neutral collisions (elastic and charge exchange) at 1.5 Torr is 45 μm. The sheath thickness from equation (2) is about 160 μm, giving an average number of 3.5 ion-neutral collisions in the sheath (the Debye length is 16 μm). No self-bias was measured on the blocking capacitor in the impedance matching box 204 due to the presence of the ceramic. The plasma potential in the region of the RF electrode 18 will be of the order of 22 V on axis (the value of 15 V measured at z=4 mm and an extra

$$\text{?} \text{?} \sim 7 V )$$

$$\text{?} \text{indicates text missing or illegible when filed}$$

and about 20 V at the radial sheath edge

$$( - \text{?} )$$

$$\text{?} \text{indicates text missing or illegible when filed}$$

which indicates that the inner wall of the ceramic tube 12 will develop a negative bias of ˜−36 V, since 0.83 βV_{rf}˜56 V at 9.5 W.

At 1.5 Torr, the gas flow of about 100 seem corresponds to 3 mg s⁻¹ or to 4.5×10¹⁹ argon atoms per second. If this were being expelled from a nozzle at the sound speed (Mach 1) of v_{g}=300 m s⁻¹, the corresponding thrust would be

$$T = \text{?} \frac{d m}{d t} \sim 0.9 mN . \\ \text{?} \text{indicates text missing or illegible when filed}$$

If 10 W (10 J of kinetic energy) are effectively transferred into heating the gas, then

$$\text{?} = {( 20 / \text{?} )}^{\frac{1}{2}} \sim 2600 {ms}^{- 1}$$

$$\text{?} \text{indicates text missing or illegible when filed}$$

(M₁ is the total mass ejected per second). However, considering all degrees of freedom, i.e. 3×(½) then

$$\text{?} = 870 {ms}^{- 1}$$

$$\text{?} \text{indicates text missing or illegible when filed}$$

along the z-axis which would correspond to a gas temperature of

$$\text{?} = \text{?} \sim 1430 K$$

$$\text{?} \text{indicates text missing or illegible when filed}$$

(k is the Boltzmann constant). This value can be increased by increasing the RF power and the gas flow can be reduced by reducing the discharge diameter or introducing pressure gradients by modifying the cavity geometry (e.g. with a nozzle). Using the particle balance discussed above but for a gas temperature of 1430 K yields a calculated electron temperature of 2.5 eV compared with 2 eV obtained with 300 K (the gas temperature which would yield the measured electron temperature of 3 eV is 3200 K).

Many modifications will be apparent to those skilled in the art without departing from the scope of the present invention.

1.-6. (canceled)

7. A plasma micro-thruster, including:
an elongate and substantially non-conductive tube having a first end to receive a supply of propellant gas, and an open second end to act as an exhaust;
first, second, and third electrodes extending circumferentially around the tube and being mutually spaced along a longitudinal axis of the tube, the third electrode being longitudinally interposed between the first and second electrodes;
wherein the tube and the first, second and third electrodes are configured to generate a plasma from propellant gas flowing though the tube from the first end of the tube when the third electrode receives radio frequency power and the first and second electrodes are electrically grounded relative to the third electrode, such that the expansion of the plasma from the open end of the tube generates a corresponding thrust.

8. A plasma micro-thruster, including:
a tube having a length greater than its width, receiving at one end a supply of propellant gas, and having the other end open as an exhaust;
a first and a second conductive electrodes in a spaced-apart arrangement surrounding the tube, each electrodes being connected to zero relative potential; and
a third conductive electrode interposed between the first and second electrodes and surrounding the tube and adapted to be supplied with radio frequency power; and
wherein a plasma is ignited within the tube with the flow of propellant gas into said tube and the application of radio frequency power to said third electrode.

9. The micro-thruster of claim 7, wherein the tube is composed of a ceramic material.

10. The micro-thruster of claim 8, wherein the tube is composed of a ceramic material.

11. The micro-thruster of claim 7, including a plenum chamber configured to supply a positive pressure of the propellant gas to the corresponding end of the tube.

12. The micro-thruster of claim 8, including a plenum chamber configured to supply a positive pressure of the propellant gas to the corresponding end of the tube.

13. The micro-thruster of claim 9, including a plenum chamber configured to supply a positive pressure of the propellant gas to the corresponding end of the tube.

14. The micro-thruster of claim 10, including a plenum chamber configured to supply a positive pressure of the propellant gas to the corresponding end of the tube.

15. The micro-thruster of claim 11, including a gas flow controller disposed between the plenum chamber and the corresponding end of the tube.

16. The micro-thruster of claim 12, including a gas flow controller disposed between the plenum chamber and the corresponding end of the tube.

17. The micro-thruster of claim 13, including a gas flow controller disposed between the plenum chamber and the corresponding end of the tube.

18. The micro-thruster of claim 14, including a gas flow controller disposed between the plenum chamber and the corresponding end of the tube.

19. The micro-thruster of claim 7, including a radio frequency power supply connected to said third electrode.

20. The micro-thruster of claim 8, including a radio frequency power supply connected to said third electrode.

21. The micro-thruster of claim 9, including a radio frequency power supply connected to said third electrode.

22. The micro-thruster of claim 10, including a radio frequency power supply connected to said third electrode.

23. The micro-thruster of claim 11, including a radio frequency power supply connected to said third electrode.

24. The micro-thruster of claim 12, including a radio frequency power supply connected to said third electrode.

25. The micro-thruster of claim 13, including a radio frequency power supply connected to said third electrode.

26. The micro-thruster of claim 14, including a radio frequency power supply connected to said third electrode.
